(19) United States
(12) Patent Application Publication
(10) Pub. No.: US 2024/0319026 A1
(43) Pub. Date: Sep. 26, 2024

(54) LOAD SENSOR

(71) Applicant: Panasonic Intellectual Property Management Co., Ltd., Osaka (JP)

(72) Inventors: Susumu URAGAMI, Kumamoto (JP); Takafumi HAMANO, Fukuoka (JP); Yuta MORIURA, Osaka (JP); Takashi MATSUMOTO, Osaka (JP); Hironobu UKITSU, Osaka (JP); Yodai MATSUMURA, Osaka (JP)

(21) Appl. No.: 18/731,914

(22) Filed: Jun. 3, 2024

Related U.S. Application Data
(63) Continuation of application No. PCT/JP2022/039371, filed on Oct. 21, 2022.

(30) Foreign Application Priority Data
Dec. 8, 2021 (JP) 2021-199237

(51) Int. Cl. G01L 1/14

(52) U.S. Cl. CPC G01L 1/14

(57) ABSTRACT

A load sensor includes: a first base member; a second base member; a plurality of electrically-conductive elastic bodies disposed so as to be arranged; a plurality of conductor wires crossing the plurality of electrically-conductive elastic bodies; a dielectric body disposed between the electrically-conductive elastic body and the conductor wire; and a thread configured to sew and fasten the plurality of conductor wires to the first base member or the second base member by a stitch row extending in a direction crossing an arrangement direction of the plurality of electrically-conductive elastic bodies. At a position of the stitch row, one of the conductor wires crosses or is close to another of the conductor wires. The thread is sewn so as to extend across the one conductor wire and the other conductor wire.

### CROSS REFERENCE TO RELATED APPLICATION

This application is a continuation of International Application No. PCT/JP2022/039371 filed on Oct. 21, 2022, entitled “LOAD SENSOR”, which claims priority under 35 U.S.C. Section 119 of Japanese Patent Application No. 2021-199237 filed on Dec. 8, 2021, entitled “LOAD SENSOR”. The disclosures of the above applications are incorporated herein by reference.

### BACKGROUND OF THE INVENTION

### Field of the Invention

The present invention relates to a load sensor that detects a load applied from outside, based on change in capacitance.

### Description of Related Art

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

International Publication No. WO2020/153029 describes a pressure-sensitive element (load sensor) that includes: a sheet-shaped base member including an elastic electrically-conductive part; a plurality of conductor wires disposed so as to cross the elastic electrically-conductive part; a plurality of dielectric bodies respectively disposed between the plurality of conductor wires and the elastic electrically-conductive part; and a thread-shaped member that sews the plurality of conductor wires to the base member.

In the load sensor as above, in order to sew and fasten a plurality of conductor wires to a base member, a sewing machine is used. However, when a large number of conductor wires are disposed in a load sensor, the interval between adjacent conductor wires is reduced, and it becomes difficult to appropriately sew and fasten each conductor wire to a base member.

### SUMMARY OF THE INVENTION

A main aspect of the present invention relates to a load sensor. The load sensor according to the present aspect includes: a first base member; a second base member disposed so as to oppose the first base member; a plurality of electrically-conductive elastic bodies disposed so as to be arranged on an opposing face of at least one of the first base member and the second base member; a plurality of conductor wires disposed so as to cross the plurality of electrically-conductive elastic bodies; a dielectric body disposed between the electrically-conductive elastic body and the conductor wire; and a thread configured to sew and fasten the plurality of conductor wires to the first base member or the second base member by a stitch row extending in a direction crossing an arrangement direction of the plurality of electrically-conductive elastic bodies. The plurality of conductor wires are disposed such that, at a position of the stitch row, one of the conductor wires crosses another of the conductor wires or is close to the other of the conductor wires, and the thread is sewn to the first base member or the second base member so as to extend across the one conductor wire and the other conductor wire that cross each other or are close to each other.

In the load sensor according to the present aspect, a plurality of conductor wires that cross each other or are close to each other at the position of the stitch row can be collectively sewn and fastened to the first base member or the second base member. In this case, the interval between the positions (sewing-and-fastening positions) at each of which the plurality of conductor wires cross each other or are close to each other becomes wider than the interval when the plurality of conductor wires are simply lined up. In general, in a sewing machine for sewing and fastening a thread, there is a minimum needle hole pitch according to the machine accuracy. Therefore, even when the plurality of conductor wires simply lined up cannot be sewn and fastened one by one due to the relationship with the minimum needle hole pitch, in the case of the load sensor according to the present aspect, the interval between the sewing-and-fastening positions is wide as described above, and thus, each conductor wire can be appropriately sewn and fastened.

The effects and the significance of the present invention will be further clarified by the description of the embodiments below. However, the embodiments below are merely some examples for implementing the present invention. The present invention is not limited to the description of the embodiments below in any way.

### BRIEF DESCRIPTION OF THE DRAWINGS

FIG. 1 is a plan view schematically showing a configuration of a structure in a manufacturing step according to Embodiment 1;

FIG. 2 is a plan view schematically showing a configuration of a structure in a manufacturing step according to Embodiment 1;

FIG. 3 is a plan view schematically showing a configuration of a structure in a manufacturing step according to Embodiment 1;

FIG. 4 is a plan view showing a configuration of a wire structure according to Embodiment 1;

FIGS. 5A and 5B each schematically show a cross section of a structure along a plane parallel to an X-Z plane at the position of a thread according to Embodiment 1;

FIG. 6 is a perspective view schematically showing a configuration of a load sensor according to Embodiment 1;

FIG. 7A and FIG. 7B each schematically show a cross section of the vicinity of a crossing position between an electrically-conductive elastic body and a wire along a plane parallel to an X-Z plane at the crossing position according to Embodiment 1;

FIG. 8 is a plan view schematically showing a configuration of the inside of the load sensor according to Embodiment 1;

FIG. 9A is a plan view schematically showing the interval between stitches of the thread according to Comparative Example;

FIG. 9B is a plan view schematically showing the interval between stitches of the thread according to Embodiment 1;

FIG. 10 is a plan view showing a configuration of the wire structure according to Modification 1 of Embodiment 1;

FIG. 11 is a plan view showing a configuration of the wire structure according to Modification 2 of Embodiment 1;

FIG. 12 is a plan view showing a configuration of the wire structure according to Modification 3 of Embodiment 1;

FIG. 13 is a plan view showing a configuration of the wire structure according to Embodiment 2;

FIG. 14 is a plan view schematically showing the interval between stitches of the thread according to Embodiment 2;

FIG. 15 is a plan view showing a configuration of the wire structure according to Modification 1 of Embodiment 2;

FIG. 16 is a plan view showing a configuration of the wire structure according to Modification 2 of Embodiment 2;

FIG. 17 is a plan view showing a configuration of the wire structure according to Modification 3 of Embodiment 2; and

FIG. 18 schematically shows a cross section of the vicinity of a crossing position between the electrically-conductive elastic body and the wire along a plane parallel to an X-Z plane at the crossing position according to another modification.

It is noted that the drawings are solely for description and do not limit the scope of the present invention in any way.

### DETAILED DESCRIPTION

A load sensor according to the present invention is applicable to a load sensor of a management system or an electronic apparatus that performs processing in accordance with an applied load.

Examples of the management system include a stock management system, a driver monitoring system, a coaching management system, a security management system, and a caregiving/nursing management system.

In the stock management system, for example, by a load sensor provided to a stock shelf, the load of a placed stock is detected, and the kinds of commodities and the number of commodities present on the stock shelf are detected. Accordingly, in a store, a factory, a warehouse, and the like, the stock can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

Examples of the electronic apparatus include a vehicle-mounted apparatus (car navigation system, audio apparatus, etc.), a household electrical appliance (electric pot, IH cooking heater, etc.), a smartphone, an electronic paper, an electronic book reader, a PC keyboard, a game controller, a smartwatch, a wireless earphone, a touch panel, an electronic pen, a penlight, lighting clothes, and a musical instrument. In an electronic apparatus, a load sensor is provided to an input part that receives an input from a user.

The load sensor in the embodiments below is a capacitance-type load sensor that is typically provided in a load sensor of a management system or an electronic apparatus as described above. Such a load sensor may be referred to as a “capacitance-type pressure-sensitive sensor element”, a “capacitive pressure detection sensor element”, a “pressure-sensitive switch element”, or the like. The load sensor in the embodiments below is connected to an external detection circuit, and the load sensor and the detection circuit form a load detection device. The embodiments below are some examples of embodiments of the present invention, and the present invention is not limited to the embodiments below in any way.

Hereinafter, embodiments of the present invention will be described with reference to the drawings. For convenience, X-, Y-, and Z-axes orthogonal to each other are indicated in the drawings. The Z-axis direction is the height direction of a load sensor 1.

### Embodiment 1

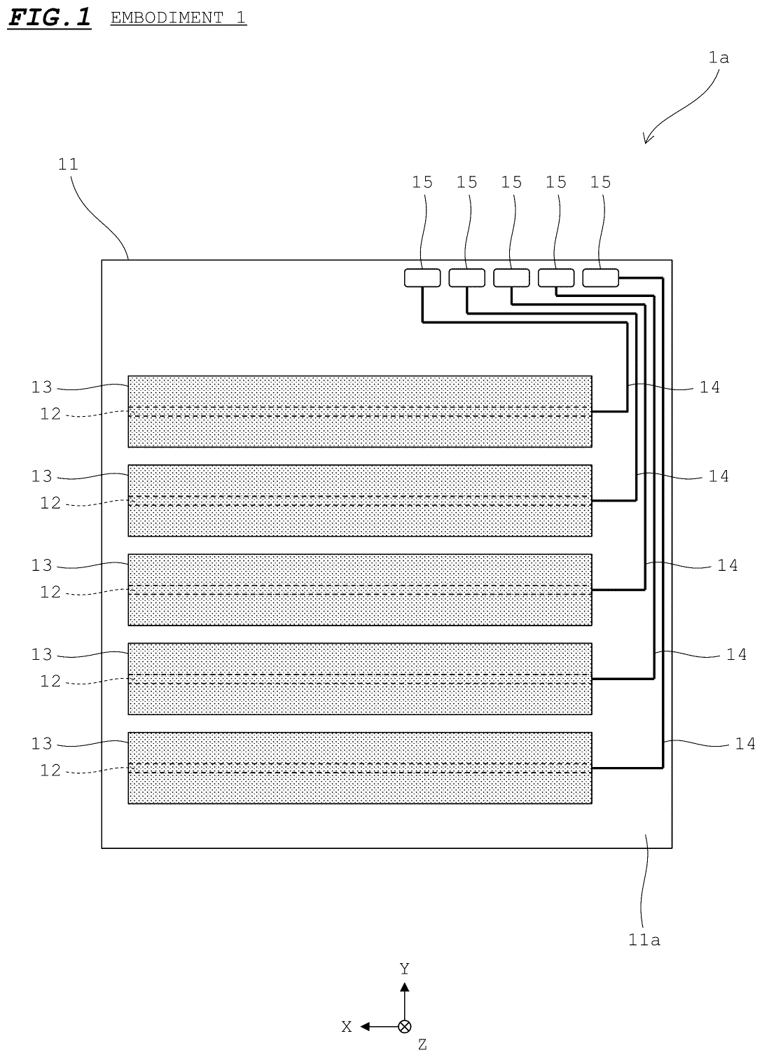

FIG. 1 is a plan view schematically showing a configuration of a structure 1a in a manufacturing step.

The structure 1a includes a first base member 11, a plurality of electric conductors 12, a plurality of electrically-conductive elastic bodies 13, a plurality of wiring cables 14, and a plurality of electrodes 15.

The first base member 11 is a flat-plate-shaped member having elasticity. The first base member 11 has a rectangular shape in a plan view. The thickness of the first base member 11 is constant. When the thickness of the first base member 11 is small, the first base member 11 may be referred to as a sheet member or a film member.

The first base member 11 has an insulation property and is formed from a non-electrically-conductive resin material or a non-electrically-conductive rubber material, for example. The resin material used in the first base member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the first base member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electric conductors 12 are formed on an opposing face 11a (the face on the Z-axis negative side) of the first base member 11. Here, five electric conductors 12 are disposed on the opposing face 11a of the first base member 11 so as to extend in the X-axis direction. Each electric conductor 12 is formed from a material having a resistance lower than that of each electrically-conductive elastic body 13. In Embodiment 1, the electric conductor 12 is an electrically-conductive member having elasticity, and the thickness of the electric conductor 12 is smaller than the thickness of the electrically-conductive elastic body 13. A wiring cable 14 is drawn from an end portion on the X-axis negative side of each electric conductor 12.

Each electrically-conductive elastic body 13 is formed on the opposing face 11a of the first base member 11 so as to cover a corresponding electric conductor 12. The electrically-conductive elastic body 13 is formed on the opposing face 11a such that the electric conductor 12 is positioned at a substantially middle position of the electrically-conductive elastic body 13 in the Y-axis direction. Here, five electrically-conductive elastic bodies 13 are disposed on the opposing face 11a of the first base member 11. The width, the length, and the thickness of the five electrically-conductive elastic bodies 13 are the same with each other.

The electrically-conductive elastic bodies 13 each have a band-like shape that is long in the X-axis direction and are arranged in the Y-axis direction with a predetermined gap therebetween. That is, the long side of the electrically-conductive elastic body 13 is parallel to the X-axis and the arrangement direction of the electrically-conductive elastic bodies 13 is parallel to the Y-axis. Each electrically-conductive elastic body 13 is an electrically-conductive member having elasticity. Each electric conductor 12 and a corresponding electrically-conductive elastic body 13 formed so as to cover the electric conductor 12 are in a state of being electrically connected to each other.

Each electric conductor 12 and each electrically-conductive elastic body 13 are formed on the opposing face 11a of the first base member 11 by a printing method such as screen printing, gravure printing, flexographic printing, offset printing, or gravure offset printing. After the electric conductor 12 has been formed, the electrically-conductive elastic body 13 is formed so as to overlap the electric conductor 12. With these printing methods, the electric conductor 12 and the electrically-conductive elastic body 13 can be formed so as to have a thickness of about 0.001 mm to 0.5 mm on the opposing face 11a of the first base member 11. However, the forming method for the electric conductor 12 and the electrically-conductive elastic body 13 is not limited to the printing method.

Each electric conductor 12 and each electrically-conductive elastic body 13 are formed from a resin material and an electrically-conductive filler dispersed therein, or from a rubber material and an electrically-conductive filler dispersed therein.

Similar to the resin material used in the first base member 11 described above, the resin material used in the electric conductor 12 and the electrically-conductive elastic body 13 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. Similar to the rubber material used in the first base member 11 described above, the rubber material used in the electric conductor 12 and the electrically-conductive elastic body 13 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler used in the electric conductor 12 and the electrically-conductive elastic body 13 is a material of at least one type selected from the group consisting of: metal materials such as Au (gold), Ag (silver), Cu (copper), C (carbon), ZnO (zinc oxide), In₂O₃ (indium oxide (III)), and SnO₂ (tin oxide (IV)); electrically-conductive macromolecule materials such as PEDOT: PSS (i.e., a complex composed of poly(3,4-ethylenedioxythiophene) (PEDOT) and polystyrene sulfonate (PSS)); and electrically-conductive fibers such as a metal-coated organic matter fiber and a metal wire (fiber state), for example.

In Embodiment 1, the electrically-conductive filler used in the electric conductor 12 is Ag (silver), and the electrically-conductive filler forming the electrically-conductive elastic body 13 is C (carbon).

Each wiring cable 14 is formed on the opposing face 11a (the face on the Z-axis negative side) of the first base member 11. Each electrode 15 is formed on the opposing face 11a of the first base member 11, near an end portion on the Y-axis positive side. Here, five electrodes 15 are arranged in the X-axis direction with a predetermined gap therebetween. The wiring cable 14 and the electrode 15 are formed from an electrically-conductive material. The wiring cable 14 electrically connects together one electric conductor 12 and one electrode 15 that form a pair.

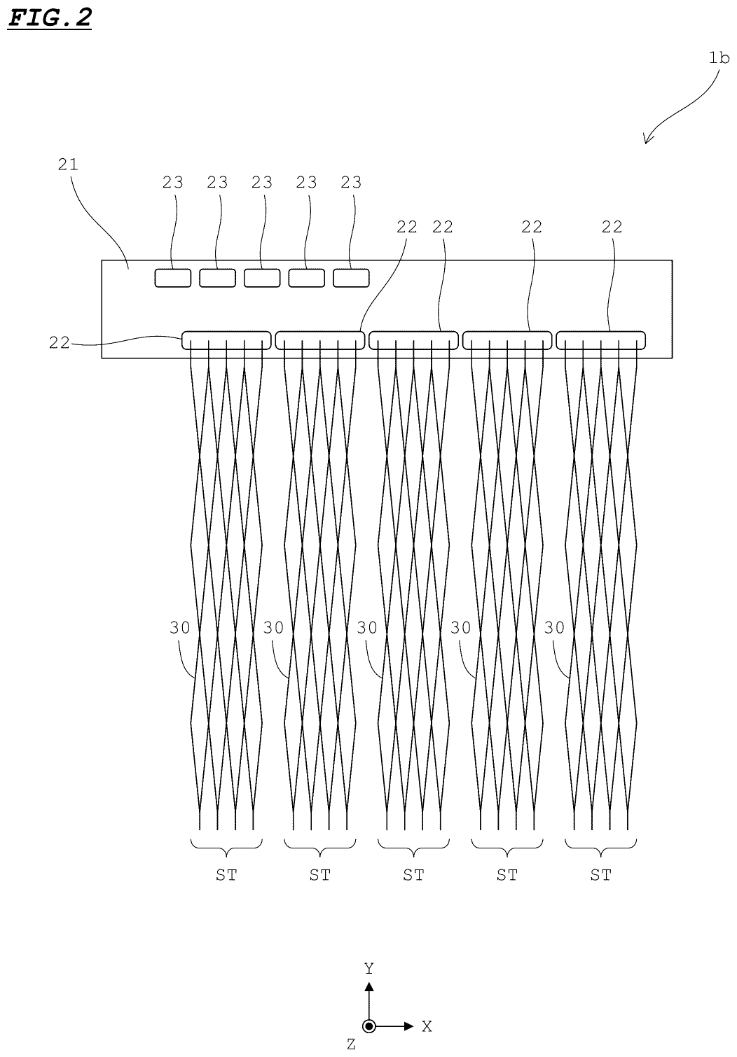

FIG. 2 is a plan view schematically showing a configuration of a structure 1b in a manufacturing step.

The structure 1b includes a substrate 21, a plurality of electrodes 22, a plurality of electrodes 23, and a plurality of wires 30.

The substrate 21 has a rectangular shape extending in the X-axis direction. The electrodes 22 are formed on the face on the Z-axis positive side of the substrate 21, near an end portion on the Y-axis negative side. Here, five electrodes 22 are arranged in the X-axis direction with a predetermined gap therebetween. The electrodes 23 are formed on the face on the Z-axis positive side of the substrate 21, near an end portion on the Y-axis positive side. Here, five electrodes 23 are arranged in the X-axis direction with a predetermined gap therebetween. The size and the pitch in the X-axis direction of the five electrodes 23 are the same as those of the five electrodes 15 shown in FIG. 1. The substrate 21 includes a terminal (not shown) at an end portion on the Y-axis positive side. This terminal is connected to the electrodes 22, 23, and is used in order to connect each electrode 22, 23 to an external detection circuit.

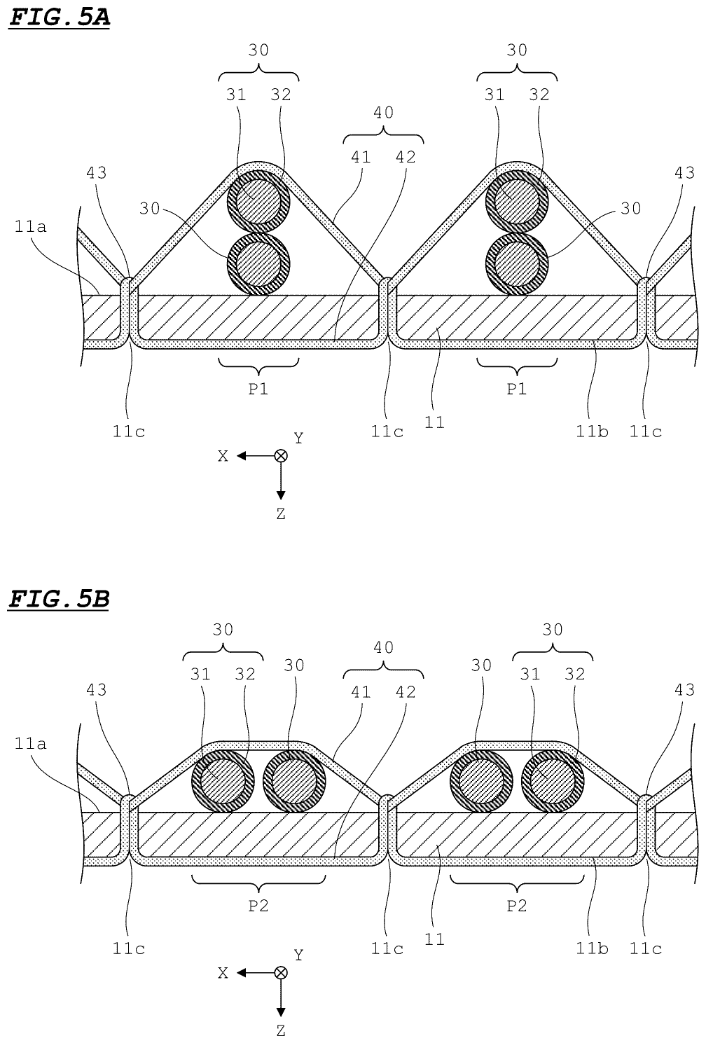

The plurality of wires 30 are disposed so as to extend in the Y-axis direction. Here, 40 wires 30 are disposed. Each wire 30 is disposed so as to be tilted in the X-axis direction by a predetermined angle with respect to the Y-axis. As described later, each wire 30 is composed of a conductor wire 31 and a dielectric body 32 covering the surface of the conductor wire 31 (see FIGS. 5A, 5B).

Eight wires 30 form one wire structure ST. Here, five wire structures ST are arranged in the X-axis direction with a predetermined gap therebetween. The eight wires 30 included in one wire structure ST are continuous, with end portions thereof being connected to each other. The eight wires 30 included in one wire structure ST cross each other in a mesh-like manner in an X-Y plane. End portions on the Y-axis positive side of the wire structures ST are connected to the electrodes 22 by using solder. In this process, the dielectric body 32 is removed from an end portion of the wire 30, and the exposed conductor wire 31 is soldered to the electrode 22.

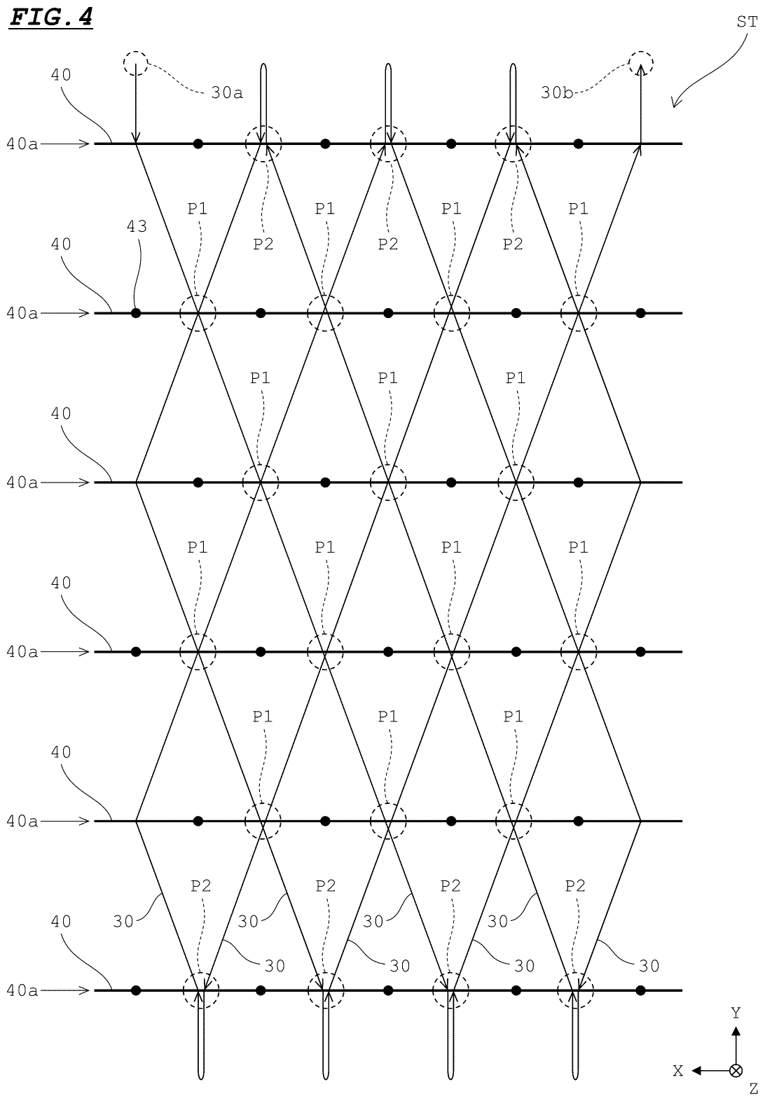

The configuration of the wire structure ST will be described later in further detail with reference to FIG. 4. The configuration of the wire 30 will be described later with reference to FIGS. 5A, 5B.

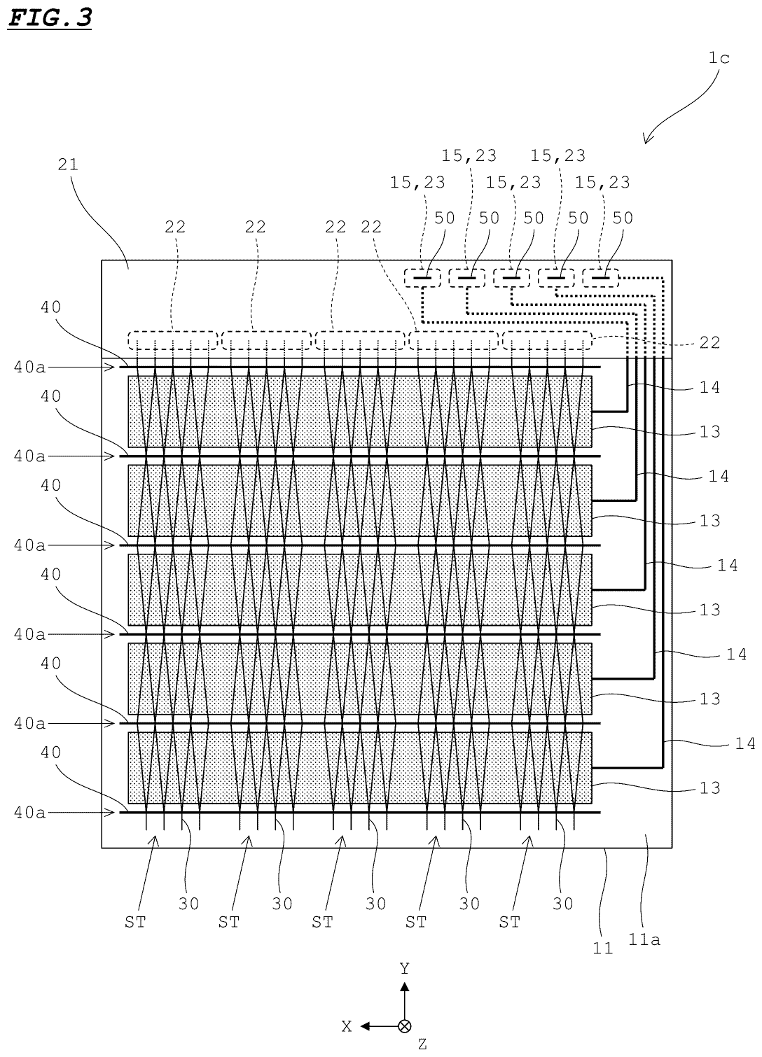

FIG. 3 is a plan view schematically showing a configuration of a structure 1c in a manufacturing step.

The structure 1b in FIG. 2 is superposed with its front face and back face reversed, from the Z-axis negative side of the structure 1a in FIG. 1. Accordingly, the face on the Z-axis positive side of the substrate 21 comes into contact with the opposing face 11a (the face on the Z-axis negative side) of the first base member 11, and the wire structures ST composed of the wires 30 come into contact with the electrically-conductive elastic bodies 13. In a state of diagonally traversing the five electrically-conductive elastic bodies 13, each wire 30 of the wire structures ST crosses these electrically-conductive elastic bodies 13.

In this state, the wires 30 of each wire structure ST are sewn and fastened by threads 40 to the opposing face 11a of the first base member 11. Sewing of the thread 40 is performed by a sewing machine, for example. As described later, the sewing machine forms needle holes 11c (see FIGS. 5A, 5B) at a predetermined pitch in the X-axis direction, and forms stitches 43 (see FIGS. 5A, 5B) at the needle holes 11c, to sew and fasten the wires 30 to the first base member 11.

A stitch row 40a of each thread 40 extends in the X-axis direction. On the stitch row 40a, the thread 40 sews and fastens, across all of the wires 30, each wire 30 to the first base member 11. In FIG. 3, six stitch rows 40a of the threads 40 are provided on the first base member 11.

In a plan view, four stitch rows 40a of the threads 40 on the inner side are each positioned in a gap between two electrically-conductive elastic bodies 13 adjacent to each other in the Y-axis direction, and two stitch rows 40a of the threads 40 on the outer side are respectively positioned on the outer side with respect to two electrically-conductive elastic bodies 13 on the outer side in the Y-axis direction. Each wire 30, in a state of being sewn and fastened by the threads 40, is movable in the Y-axis direction, and is restricted in movement in the X-axis direction by the threads 40. The thread 40 is implemented by a chemical fiber, a natural fiber, a mixed fiber of the chemical fiber and the natural fiber, or the like.

As a result of the structure 1b being superposed on the structure 1a, the electrodes 15 on the first base member 11 side and the electrodes 23 on the substrate 21 side come into contact with each other. In this state, at the positions of the electrodes 15, 23, the first base member 11 and the substrate 21 are sewn and fastened to each other by threads 50. Accordingly, the electrodes 15, 23 are joined to each other.

FIG. 4 is a plan view showing a configuration of the wire structure ST.

In the wire structure ST, a plurality of wires 30 are disposed along a plurality of straight lines tilted with respect to the Y-axis direction, whereby a plurality of meshes are formed. That is, the plurality of wires 30 are disposed in non-parallel to the arrangement direction (the Y-axis direction) of the electrically-conductive elastic bodies 13, whereby the meshes of the wire structure ST are formed. There are two kinds of the tilt direction of the wire 30, i.e., the X-axis positive direction and the X-axis negative direction, and the tilt angles of the two kinds of the tilt direction are the same with each other.

In Embodiment 1, end portions of the wires 30 adjacent to each other in the end portions in the Y-axis direction are connected to each other, whereby the eight wires 30 are continuous. In FIG. 4, a route from an end portion 30a to an end portion 30b when the eight wires 30 are disposed in a continuous manner is indicated by solid line arrows. The eight wires 30 are disposed in a continuous manner along this route, whereby the mesh of the wire structure ST is formed.

Here, at each position P1 on the stitch row 40a, two wires 30 cross each other. The positions P1 are arranged with a predetermined gap therebetween in the X-axis direction. The thread 40 is sewn to the first base member 11 so as to extend across two wires 30 crossing each other at each position P1. At each position P2 on the stitch row 40a, two wires 30 are close to each other. The positions P2 are arranged with a predetermined gap therebetween in the X-axis direction. The thread 40 is sewn to the first base member 11 so as to extend across the two wires 30 close to each other at each position P2. At this time, a stitch 43 is formed between adjacent two positions P1, and a stitch 43 is formed between adjacent two positions P2. A plurality of the stitch rows 40a of the threads 40 extending in the X-axis direction are formed with a predetermined gap therebetween in the Y-axis direction.

FIGS. 5A, 5B each schematically show a cross section of the structure 1c in FIG. 3, along a plane parallel to an X-Z plane at the position of the thread 40 passing through the positions P1, P2.

As shown in FIGS. 5A, 5B, each wire 30 is composed of the conductor wire 31 and the dielectric body 32 formed on the conductor wire 31. The dielectric body 32 is formed on the outer periphery of the conductor wire 31 and covers the surface of the conductor wire 31 over the entire periphery thereof.

Each conductor wire 31 is a member having electrical conductivity and having a linear shape. The conductor wire 31 is formed from an electrically-conductive metal material, for example. Other than this, the conductor wire 31 may be composed of a core wire made of glass and an electrically-conductive layer formed on the surface of the core wire. Alternatively, the conductor wire 31 may be composed of a core wire made of resin, and an electrically-conductive layer formed on the surface of the core wire, for example. For example, as the conductor wire 31, a valve action metal such as aluminum (Al), titanium (Ti), tantalum (Ta), niobium (Nb), zirconium (Zr), or hafnium (Hf); tungsten (W); molybdenum (Mo); copper (Cu); nickel (Ni); silver (Ag); gold (Au); or the like is used. In Embodiment 1, the conductor wire 31 is formed from copper. The conductor wire 31 may be a twisted wire obtained by twisting wire members made of an electrically-conductive metal material.

The dielectric body 32 has an electric insulation property, and is formed from a resin material, a ceramic material, a metal oxide material, or the like, for example. The dielectric body 32 may be a resin material of at least one type selected from the group consisting of a polypropylene resin, a polyester resin (e.g., polyethylene terephthalate resin), a polyimide resin, a polyphenylene sulfide resin, a polyvinyl formal resin, a polyurethane resin, a polyamide imide resin, a polyamide resin, and the like. Alternatively, the dielectric body 32 may be a metal oxide material of at least one type selected from the group consisting of Al₂O₃, Ta₂O₅, and the like.

The diameter of the conductor wire 31 is 0.01 mm or more and 1.5 mm or less, for example, or may be 0.05 mm or more and 0.8 mm or less. Such a configuration of the conductor wire 31 is preferable from the viewpoint of the resistance and the strength of the conductor wire 31. The thickness of the dielectric body 32 is preferably 5 nm or more and 100 μm or less, and can be selected as appropriate according to the design of the sensitivity of the sensor and the like.

As shown in FIGS. 5A, 5B, the thread 40 is composed of a needle thread 41 provided along the face (the opposing face 11a) on the upper side of the first base member 11 and a bobbin thread 42 provided along the face (an upper face 11b) on the lower side of the first base member 11. The needle thread 41 and the bobbin thread 42 cross each other at the position of each needle hole 11c penetrating the first base member 11 in the Z-axis direction, and a stitch 43 is formed at this crossing position. The thread 40 is sewn to the first base member 11 along the X-axis direction, so as to extend across the positions P1, P2 shown in FIG. 4. Accordingly, a plurality of stitches 43 are arranged in the X-axis direction.

The plurality of stitches 43 arranged in the X-axis direction and the thread 40 between adjacent stitches 43 form the stitch row 40a of the thread 40. As shown in FIG. 4, a plurality of the stitch rows 40a of the threads 40 are formed, at a predetermined pitch in the Y-axis direction, on the opposing face 11a of the first base member 11. Each wire 30 is sewn and fastened to the first base member 11 by the thread 40, between adjacent stitches 43 on each of the stitch rows 40a. As shown in FIG. 5A, at each position P1, two wires 30 crossing each other are sewn and fastened to the first base member 11 by the thread 40, between adjacent stitches 43. As shown in FIG. 5B, at each position P2, two wires 30 close to each other are sewn and fastened to the first base member 11 by the thread 40, between adjacent stitches 43.

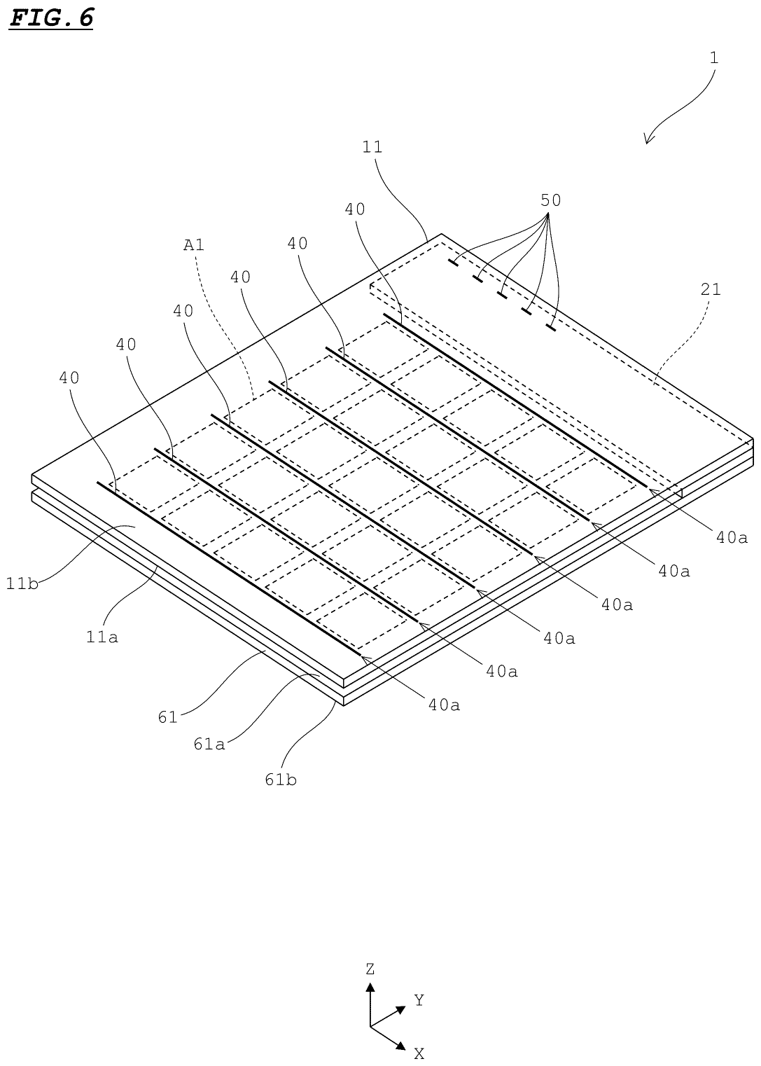

FIG. 6 is a perspective view schematically showing a configuration of the load sensor 1.

The load sensor 1 includes the structure 1c in FIG. 3 and a second base member 61.

The second base member 61 is a flat-plate-shaped member. The second base member 61 is disposed so as to oppose the face (the opposing face 11a) on the lower side of the first base member 11. The second base member 61 has a shape similar to that of the first base member 11 in a plan view. The thickness of the second base member 61 is constant. When the thickness of the second base member 61 is small, the second base member 61 may be referred to as a sheet member or a film member.

The second base member 61 has an insulation property and is formed from a non-electrically-conductive resin material or a non-electrically-conductive rubber material, for example. The second base member 61 is formed from a material that can be used in the first base member 11 described above, for example. The second base member 61 may be formed from a hard material that is less likely to be elastically deformed.

The second base member 61 is placed on the structure 1c in FIG. 3 from below (the Z-axis negative side). Accordingly, the wires 30 come into contact with an opposing face 61a (the face on the Z-axis positive side) of the second base member 61. Then, the outer periphery of the first base member 11 is connected to the second base member 61 by a thread (not shown). Accordingly, the first base member 11 is fixed to the second base member 61. Then, the load sensor 1 is completed as shown in FIG. 6.

The load sensor 1 is used in a state where the first base member 11 is oriented to the upper side (the Z-axis positive side) and the second base member 61 is oriented to the lower side (the Z-axis negative side). In this case, the upper face 11b of the first base member 11 serves as the face to which a load is applied, and a lower face 61b of the second base member 61 is set on an installation surface.

Here, in the load sensor 1, in a plan view, a plurality of element parts A1 arranged in a matrix shape are formed. In the load sensor 1 in FIG. 6, a total of 25 element parts A1 arranged in the X-axis direction and the Y-axis direction are formed. One element part A1 corresponds to a region including the intersection between one electrically-conductive elastic body 13 and one wire structure ST disposed below the electrically-conductive elastic body 13. That is, one element part A1 includes the first base member 11, the electric conductor 12, the electrically-conductive elastic body 13, the wire structure ST, and the second base member 61 that are near the intersection. When the lower face (the lower face 61b of the second base member 61) of the load sensor 1 is set on a predetermined installation surface, and a load is applied to the upper face (the upper face 11b of the first base member 11) of the load sensor 1 forming the element part A1, the capacitance between the electrically-conductive elastic body 13 and the conductor wires 31 changes, and the load is detected based on the capacitance.

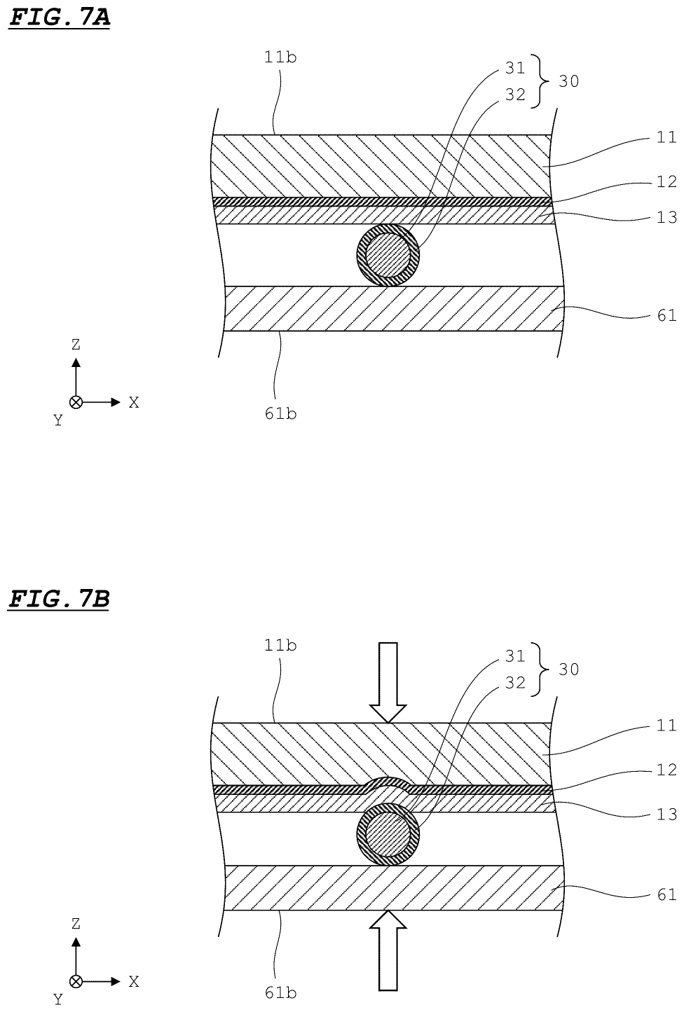

FIGS. 7A, 7B each schematically show a cross section of the vicinity of the crossing position between the electrically-conductive elastic body 13 and the wire 30 along a plane parallel to an X-Z plane at the crossing position.

FIG. 7A shows a state where no load is applied, and FIG. 7B shows a state where loads are applied. In FIGS. 7A, 7B, the lower face 61b on the Z-axis negative side of the second base member 61 is set on the installation surface.

As shown in FIG. 7A, when no load is applied, the force applied between the electrically-conductive elastic body 13 and the wire 30 is substantially zero. From this state, when a load is applied in the downward direction to the upper face 11b of the first base member 11 as shown in FIG. 7B, the electrically-conductive elastic body 13 is deformed by the wire 30. At this time, the wire 30 is brought close to the electrically-conductive elastic body 13 so as to be wrapped by the electrically-conductive elastic body 13, and the contact area between the wire 30 and the electrically-conductive elastic body 13 increases. Accordingly, the capacitance between the conductor wire 31 and the electrically-conductive elastic body 13 changes. Then, the potential reflecting the change in this capacitance is measured by the detection circuit, whereby the load is calculated.

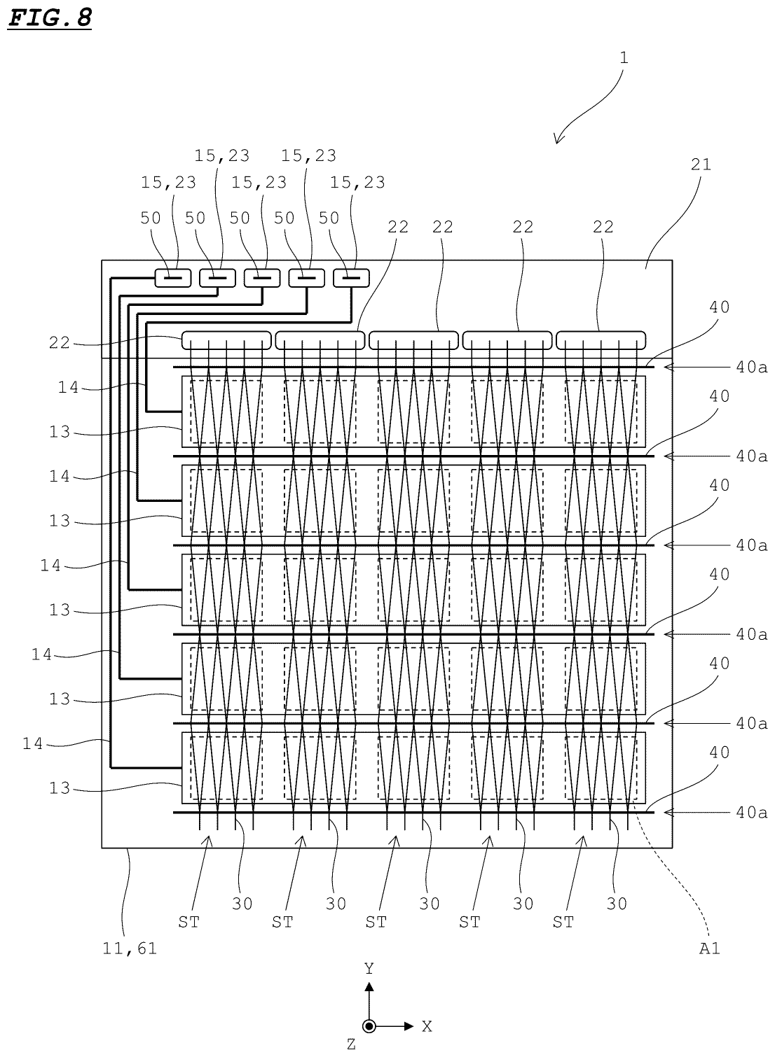

FIG. 8 is a plan view schematically showing a configuration of the inside of the load sensor 1 when viewed in the Z-axis negative direction. In FIG. 8, for convenience, as for the first base member 11, the electrically-conductive elastic bodies 13, and the substrate 21, only the contours thereof are shown. As described above, in the load sensor 1, an element part A1 is formed in the region of the intersection between an electrically-conductive elastic body 13 and a wire structure ST, and a plurality of the element parts A1 are arranged in a matrix shape. The electrodes 15, 22, 23 are connected via the substrate 21 to the detection circuit (not shown) including a load detection circuit.

The detection circuit detects the value of the capacitance for each element part A1 while switching the electrically-conductive elastic body 13 and the wire structure ST corresponding to the element part A1 serving as the detection target. Specifically, the detection circuit applies a DC voltage via a resistor to the electrically-conductive elastic body 13 and the wire structure ST crossing each other in the element part A1 serving as the detection target, and measures the voltage value at this crossing position. The voltage value at the crossing position increases according to the time constant defined by this resistor and the capacitance (the capacitance between the electrically-conductive elastic body 13 and the eight conductor wires 31 arranged in the X-axis direction) at the crossing position.

The capacitance at the crossing position has a magnitude corresponding to the load being applied at the crossing position. That is, in accordance with the load applied at the crossing position, the contact area of the dielectric body 32 with respect to the electrically-conductive elastic body 13 changes. The capacitance at the crossing position has a value corresponding to this contact area. At a predetermined timing after elapse of a certain period from the start of the application of the DC voltage, the detection circuit measures the voltage value at the crossing position, and based on the measured voltage value, acquires the load of the element part A1 corresponding to the crossing position. Accordingly, the load in each element part A1 is detected.

Meanwhile, when the number of the wires 30 disposed in each element part A1 is increased, change in the contact area during load application becomes large. Accordingly, the sensitivity of each element part A1 can be enhanced, and the dynamic range can be widened. However, on the other hand, when the number of the wires 30 disposed in each element part A1 is increased, the interval in the X-axis direction of the wires 30 is reduced. Therefore, it becomes difficult to sew and fasten the wires 30 to a base member.

In Embodiment 1, since the wires 30 are disposed as described above, this problem is solved. In the following, this will be described in comparison with Comparative Example.

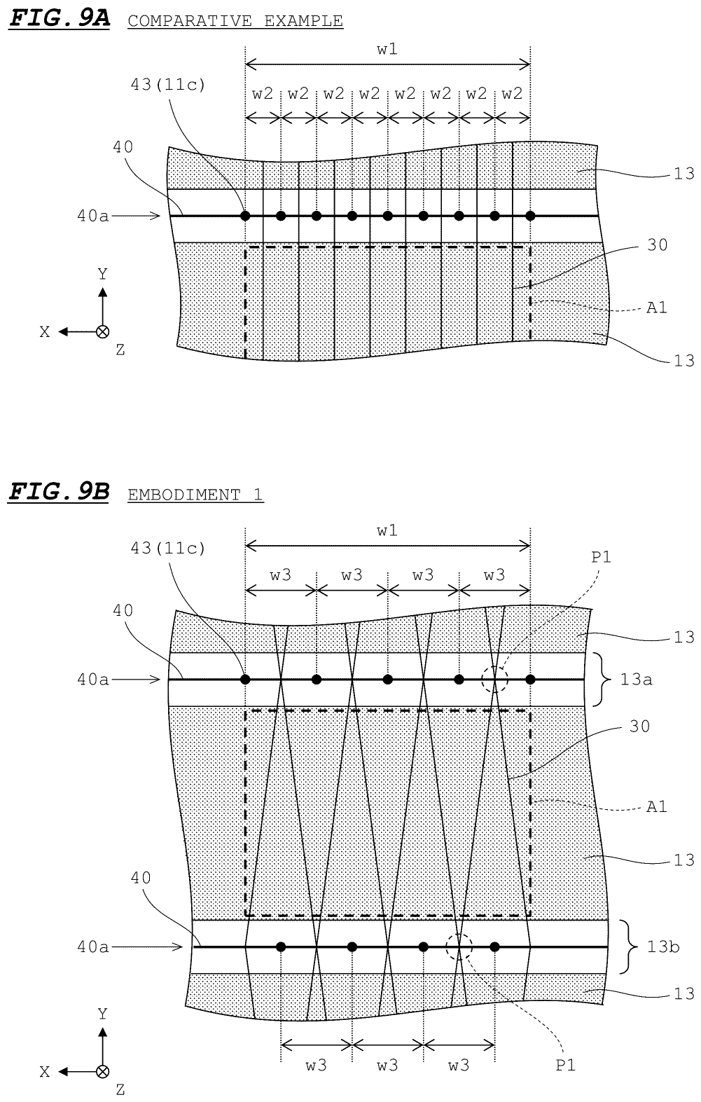

FIG. 9A is a plan view schematically showing the interval between the stitches 43 of the thread 40 according to Comparative Example.

In Comparative Example, from the viewpoint of improving the sensitivity and the dynamic range of the element parts A1, eight wires 30 are disposed in one element part A1, as in Embodiment 1. However, in Comparative Example, the eight wires 30 each extend in a straight line shape in parallel to the Y-axis and are arranged with a predetermined gap therebetween in the X-axis direction. In this case, since one wire 30 needs to be sewn and fastened by the thread 40 between adjacent stitches 43, when the width in the X-axis direction of an element part A1 is defined as w1, a pitch (needle hole pitch) w2 of the needle holes 11c of Comparative Example is w1/8. Therefore, when the width w1 of the element part A1 is 10 mm, the needle hole pitch w2 of Comparative Example is 1.25 mm.

However, as described above, when sewing of the thread 40 to the first base member 11 is performed by a sewing machine, the minimum pitch of the needle holes 11c is about 2 mm in general, according to the machine accuracy of the sewing machine. Therefore, when the wires 30 are disposed as in FIG. 9A, it becomes difficult to provide two needle holes 11c so as to sandwich one wire 30, and it becomes difficult to appropriately sew the wires 30 to the first base member 11 as shown in FIG. 9A.

In contrast, in Embodiment 1, as shown in FIG. 4, the plurality of wires 30 are disposed in the X-axis direction such that one wire 30 crosses another wire 30 at each position P1.

FIG. 9B is a plan view schematically showing the interval between the stitches 43 of the thread 40 according to Embodiment 1.

In Embodiment 1, similar to Comparative Example, eight wires 30 are included in one element part A1. However, in Embodiment 1, different from Comparative Example, two wires 30 cross each other in the gap between two electrically-conductive elastic bodies 13. In the example in FIG. 9B, in a gap 13a on the upper side, the number of the positions P1 at which the wires 30 cross each other is four, and in a gap 13b on the lower side, the number of the positions P1 at which the wires 30 cross each other is five. Therefore, when two wires 30 are collectively sewn and fastened at these positions, a pitch (needle hole pitch) w3 of the needle holes 11c is w1/4, and when the width w1 of the element part A1 is 10 mm, the needle hole pitch w3 in Embodiment 1 is 2.5 mm.

Thus, according to Embodiment 1, the needle hole pitch w3 of the needle holes 11c in the X-axis direction through the positions P1 is larger than the minimum pitch, i.e., 2 mm, of the needle holes 11c based on the machine accuracy of the sewing machine. Therefore, in the stitch row 40a passing through the positions P1, it becomes possible to provide two stitches 43 so as to sandwich two wires 30 crossing each other. Therefore, in the stitch row 40a passing through the positions P1, the wires 30 can be appropriately sewn to the first base member 11.

As for the position P2 (see FIG. 4), the plurality of wires 30 are disposed in the X-axis direction such that one wire 30 and another wire 30 are close to each other. Accordingly, on the outer side of the two electrically-conductive elastic bodies 13 on the outer side in the Y-axis direction, the number of the positions P2 at which the wires 30 are close to each other is four or five. Therefore, in this case as well, similar to the above, the needle hole pitch w3 is w1/4. Therefore, in the stitch row 40a passing through the positions P2, the wires 30 can be appropriately sewn to the first base member 11.

### Effects of Embodiment 1

According to Embodiment 1, the following effects are exhibited.

A plurality of the wires 30 (the conductor wires 31) crossing each other at the position P1 on the stitch row 40a can be collectively sewn and fastened to the first base member 11. In this case, the interval between the positions (sewing-and-fastening positions) at each of which a plurality of the wires 30 (the conductor wires 31) cross each other becomes wider than the interval when the plurality of the wires 30 (the conductor wires 31) are simply lined up as in Comparative Example in FIG. 9A. In general, in a sewing machine for sewing and fastening a thread, there is a minimum needle hole pitch according to the machine accuracy. Therefore, even when the plurality of the wires (the conductor wires 31) simply lined up cannot be sewn and fastened one by one due to the relationship with the minimum needle hole pitch, in the case of the load sensor 1 of Embodiment 1, the interval between the sewing-and-fastening positions is wide as described above, and thus, each wire 30 (the conductor wire 31) can be appropriately sewn and fastened.

As shown in FIG. 3, in a plan view, each stitch row 40a is disposed in the gap (e.g., the gap 13a, 13b in FIG. 9B) between adjacent electrically-conductive elastic bodies 13. Accordingly, the stitch row 40a does not overlap the element part A1, and thus, influence of the stitch row 40a on the load detection can be suppressed. Therefore, the load can be accurately detected.

As shown in FIG. 4, in a plan view, the plurality of wires 30 (the conductor wires 31) are disposed along a plurality of straight lines tilted with respect to the arrangement direction (the Y-axis direction) of the electrically-conductive elastic bodies 13, to form a plurality of meshes. Accordingly, the vertexes of the meshes, i.e., the positions P1 at each of which two wires 30 (the conductor wires 31) cross each other, are easily arranged at a predetermined pitch in a straight line shape. Therefore, the wires 30 (the conductor wires 31) can be easily sewn to the first base member 11.

As shown in FIG. 4, the plurality of wires 30 (the conductor wires 31) are configured to be continuous, with end portions thereof being connected to each other. Accordingly, as compared with a case where the wires 30 (the conductor wires 31) are individually disposed, the plurality of wires 30 (the conductor wires 31) can be easily disposed.

The pitch of the stitches 43 on the stitch row 40a is 2 mm or more. In general, the needle hole pitch of a sewing machine is about 2 mm at minimum according to the machine accuracy. Thus, even when the needle hole pitch of the sewing machine can be set only to be as small as about 2 mm, a plurality of the wires 30 (the conductor wires 31) can be collectively sewn and fastened between adjacent stitches having a pitch of 2 mm or more. Therefore, each wire 30 (the conductor wire 31) can be appropriately sewn and fastened.

As shown in FIG. 8, a plurality of sets each composed of: the plurality of electrically-conductive elastic bodies 13; and a wire structure ST composed of the plurality of wires 30 (the conductor wires 31) are disposed in a direction (the X-axis direction) crossing the arrangement direction (the Y-axis direction) of the electrically-conductive elastic bodies 13. Accordingly, the number of the element parts A1 can be increased, and a load can be detected in a wider range.

As shown in FIGS. 5A, 5B, the dielectric body 32 is set so as to cover the surface of each conductor wire 31. With this configuration, the dielectric body 32 can be disposed between the electrically-conductive elastic body 13 and the conductor wire 31 by merely covering the surface of the conductor wire 31 with the dielectric body 32.

### Modification 1 of Embodiment 1

In Embodiment 1, as shown in FIG. 4, the wire structure ST is composed of the wires 30 that are non-parallel to the arrangement direction (the Y-axis direction) of the electrically-conductive elastic bodies 13. However, all of the wires 30 need not necessarily be non-parallel to the Y-axis direction, and some wires 30 or a part of the wires 30 may be parallel to the Y-axis direction.

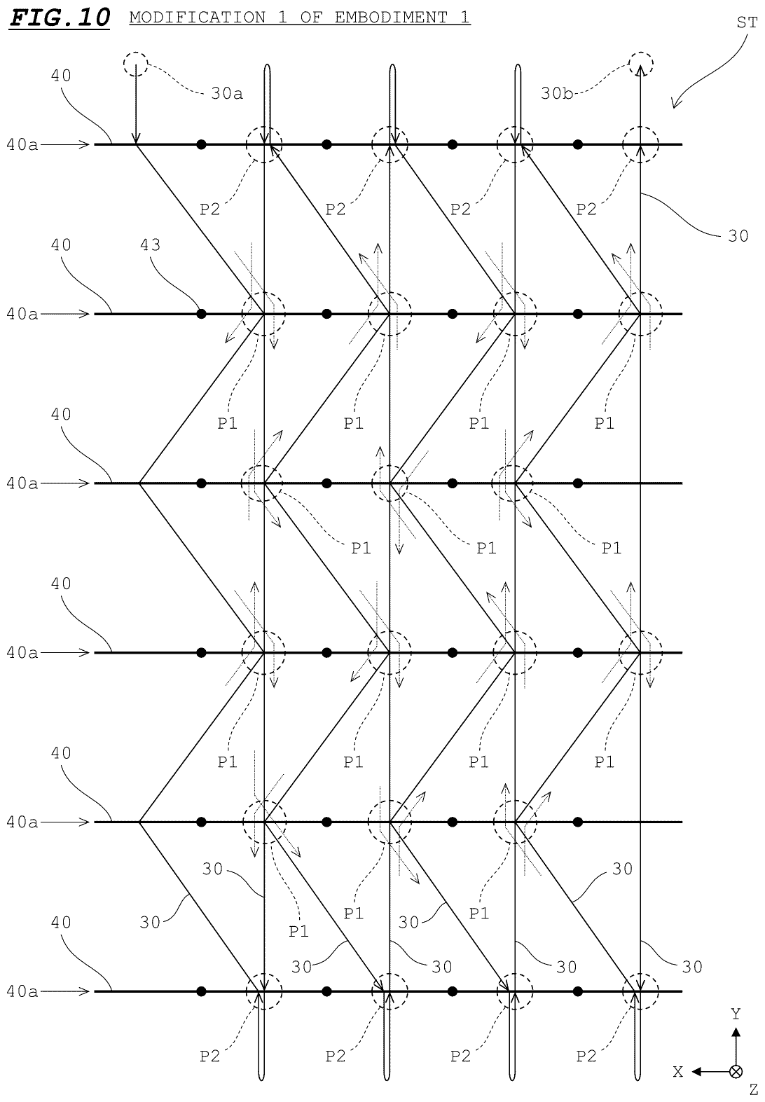

FIG. 10 is a plan view showing a configuration of the wire structure ST according to Modification 1 of Embodiment 1.

In the present modification as well, similar to Embodiment 1, in the wire structure ST, a plurality of meshes are formed by the plurality of wires 30 each extending in a straight line shape. However, in the present modification, in each wire 30 extending from the Y-axis positive side to the Y-axis negative side, a portion parallel to the Y-axis direction and a portion non-parallel to the Y-axis direction are provided. There are two kinds of the tilt direction of the wire 30 of the portion non-parallel to the Y-axis direction, i.e., the X-axis positive direction and the X-axis negative direction, and the tilt angles of the two kinds of the tilt direction are the same with each other.

In the present modification as well, end portions of the wires 30 adjacent to each other in the end portions in the Y-axis direction are connected to each other, whereby the eight wires 30 are continuous. In FIG. 10, a route from the end portion 30a to the end portion 30b when the eight wires 30 are disposed in a continuous manner is indicated by solid line arrows.

At the position P1 of the present modification as well, similar to the configuration shown in FIG. 5A, two wires 30 crossing each other are sandwiched between adjacent two stitches 43, and these two wires 30 are sewn and fastened to the first base member 11 by the thread 40. At the position P2 on the stitch row 40a of Modification 1 as well, similar to the configuration shown in FIG. 5B, two wires 30 close to each other are sandwiched between adjacent two stitches 43, and these two wires 30 are sewn and fastened to the first base member 11 by the thread 40.

Thus, in Modification 1 of Embodiment 1 as well, similar to Embodiment 1, a plurality of the conductor wires 31 crossing each other at the position P1 on the stitch row 40a can be collectively sewn and fastened to the first base member 11. Therefore, the interval between the sewing-and-fastening positions can be made wide, and thus, each conductor wire 31 can be appropriately sewn and fastened.

### Modification 2 of Embodiment 1

In Embodiment 1, as shown in FIG. 4, the wire structure ST is composed of the wires 30 each extending in a straight line shape. However, all of the wires 30 need not necessarily extend in a straight line shape, and some wires 30 or a part of the wires 30 may extend in a curved shape.

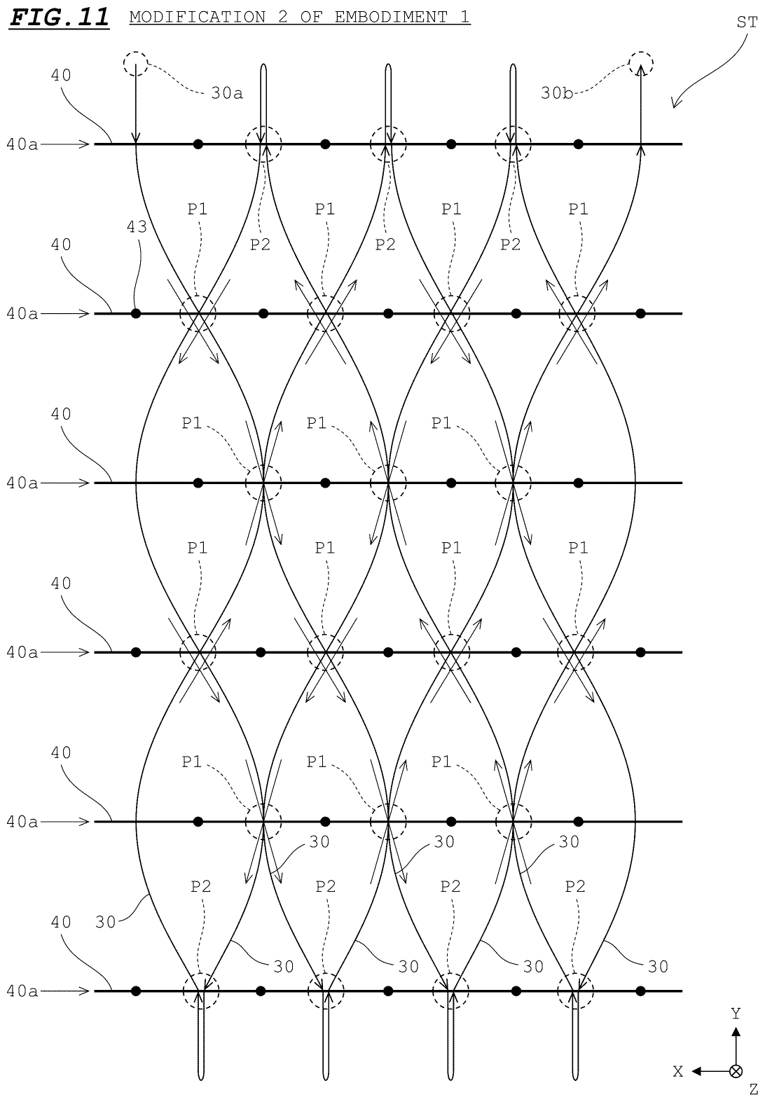

FIG. 11 is a plan view showing a configuration of the wire structure ST according to Modification 2 of Embodiment 1.

In the present modification as well, in the wire structure ST, a plurality of meshes are formed by the plurality of wires 30 that meander when disposed. In the present modification as well, end portions of the wires 30 adjacent to each other in the end portions in the Y-axis direction are connected to each other, whereby the eight wires 30 are continuous. In FIG. 11, a route from the end portion 30a to the end portion 30b when the eight wires 30 are disposed in a continuous manner is indicated by solid line arrows.

Thus, in Modification 2 of Embodiment 1 as well, similar to Embodiment 1, a plurality of the conductor wires 31 crossing each other at the position P1 on the stitch row 40a can be collectively sewn and fastened to the first base member 11. Therefore, the interval between the sewing-and-fastening positions can be made wide, and thus, each conductor wire 31 can be appropriately sewn and fastened.

### Modification 3 of Embodiment 1

In Embodiment 1, as shown in FIG. 4, end portions of the wires 30 adjacent to each other in the end portions in the Y-axis direction are connected to each other, whereby the eight wires 30 are continuous. However, not limited thereto, each wire 30 may be divided from each other.

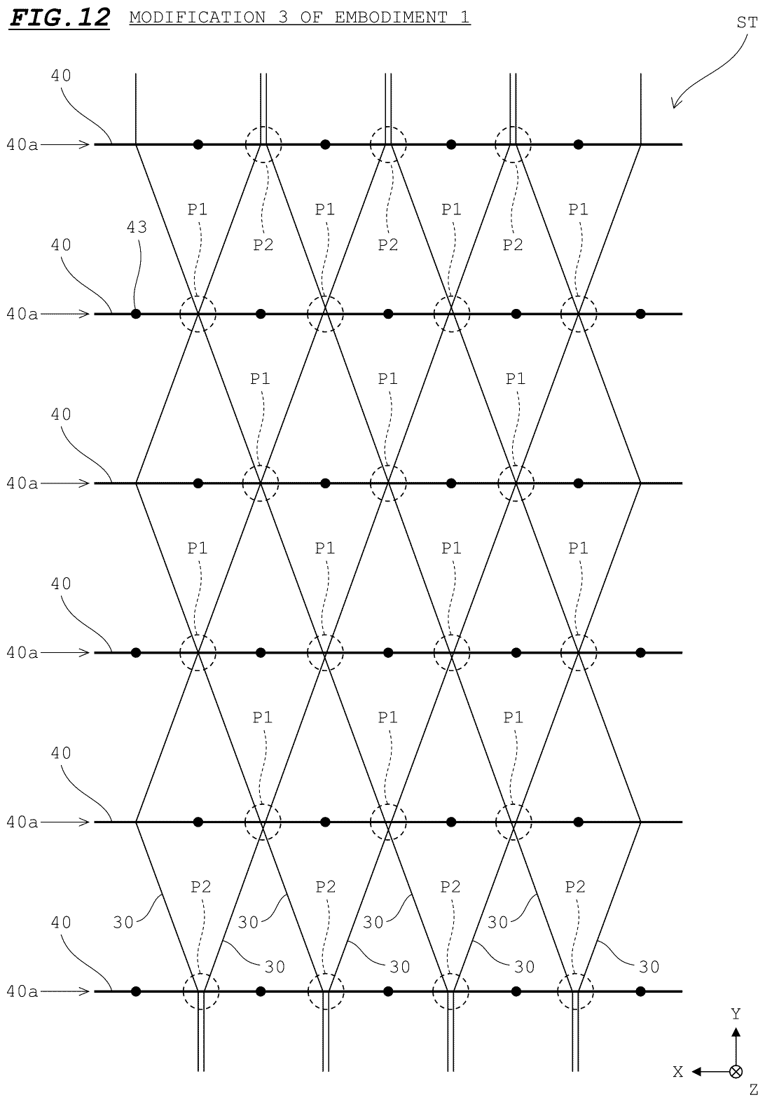

FIG. 12 is a plan view showing a configuration of the wire structure ST according to Modification 3 of Embodiment 1.

As compared with Embodiment 1 shown in FIG. 4, the wire structure ST of the present modification is not composed of the wires 30 that are continuous. That is, in the present modification, eight wires 30 that are non-parallel to the Y-axis direction are each independently disposed. The mesh shape in a plan view of the present modification is similar to that in Embodiment 1.

As in the present modification, when the plurality of wires 30 are independently disposed, it becomes necessary to individually dispose the plurality of wires 30 when assembling the load sensor 1. Therefore, when the plurality of wires 30 are configured to be continuous as in Embodiment 1, it is easier to dispose the plurality of wires 30.

### Embodiment 2

In Embodiment 1, two wires 30 cross each other in the gap between adjacent electrically-conductive elastic bodies 13. However, the plurality of wires 30 may be disposed such that two wires 30 are close to each other in the gap between adjacent electrically-conductive elastic bodies 13. The configuration of Embodiment 2 is the same as that of Embodiment 1 except the wire structure ST.

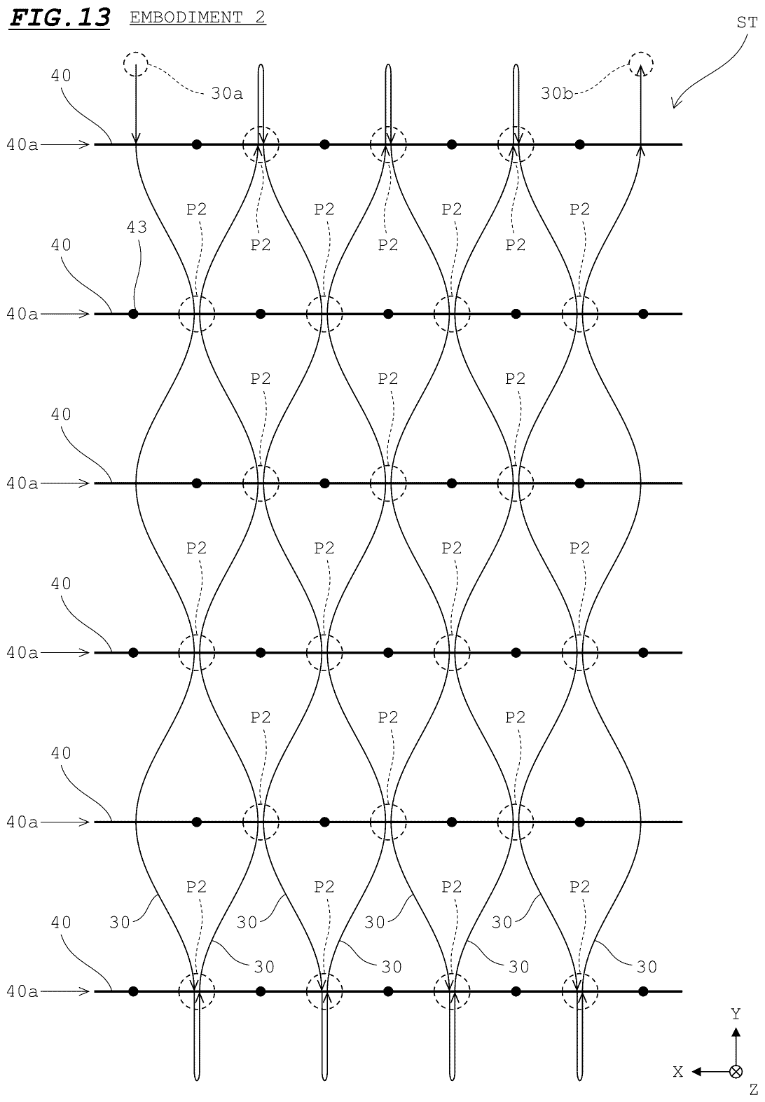

FIG. 13 is a plan view showing a configuration of the wire structure ST according to Embodiment 2.

In the wire structure ST of Embodiment 2, the plurality of wires 30 each have a wave shape meandering in the direction (the X-axis direction) of the stitch row 40a. The amplitude directions of adjacent wires 30 are opposite to each other, and the amplitudes of adjacent wires 30 are the same with each other. In Embodiment 2, end portions of the wires 30 adjacent to each other are connected to each other, whereby the plurality of wires 30 are continuous. In FIG. 13, a route from the end portion 30a to the end portion 30b when the eight wires 30 are disposed in a continuous manner is indicated by solid line arrows.

Here, at each position P2 on the stitch row 40a, two wires 30 are close to each other. The positions P2 are arranged with a predetermined gap therebetween in the X-axis direction. The thread 40 is sewn to the first base member 11 so as to extend across two wires 30 close to each other at each position P2. At this time, a stitch 43 is formed between adjacent two positions P2. A plurality of the stitch rows 40a of the threads 40 extending in the X-axis direction are formed with a predetermined gap therebetween in the Y-axis direction.

At the position P2 of Embodiment 2 as well, similar to the configuration shown in FIG. 5B, two wires 30 close to each other are sandwiched between adjacent two stitches 43, and these two wires 30 are sewn and fastened to the first base member 11 by the thread 40.

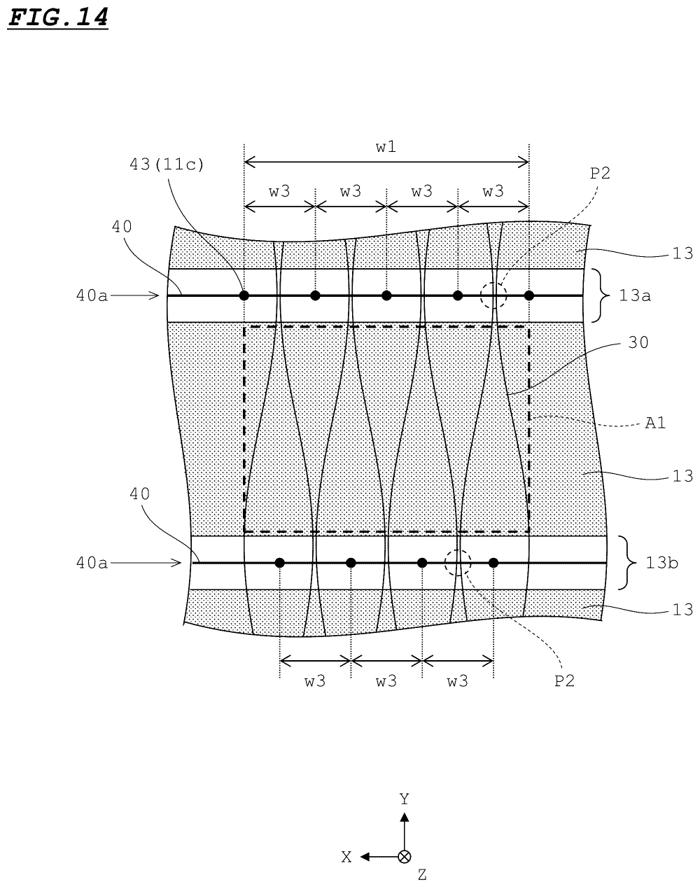

FIG. 14 is a plan view schematically showing the interval between the stitches 43 of the thread 40 according to Embodiment 2.

In Embodiment 2 as well, similar to Embodiment 1, eight wires 30 are included in each element part A1. In Embodiment 2, at each position P2, two wires 30 are close to each other. Accordingly, in the gap 13a on the upper side between two electrically-conductive elastic bodies 13, the number of the positions P2 is four and, in the gap 13b on the lower side, the number of the positions P2 is five. Therefore, the pitch (needle hole pitch) w3 of the needle holes 11c is w1/4 as in Embodiment 1, and when the width w1 of the element part A1 is 10 mm, the needle hole pitch w3 of Embodiment 2 is 2.5 mm.

Thus, in Embodiment 2 as well, the needle hole pitch w3 of the needle holes 11c in the X-axis direction through the positions P2 is larger than the minimum pitch, i.e., 2 mm, of the needle holes 11c based on the machine accuracy of the sewing machine. Therefore, in the stitch row 40a passing through the positions P2, it becomes possible to provide two stitches 43 so as to sandwich two wires 30 close to each other. Therefore, in the stitch row 40a passing through the positions P2, the wires 30 can be appropriately sewn to the first base member 11.

Thus, according to Embodiment 2, similar to Embodiment 1, a plurality of the wires 30 (the conductor wires 31) close to each other at the position P2 on the stitch row 40a can be collectively sewn and fastened to the first base member 11. Therefore, the interval between the sewing-and-fastening positions can be made wide, and thus, each wire 30 (the conductor wire 31) can be appropriately sewn and fastened.

As shown in FIG. 13, the plurality of wires 30 (the conductor wires 31) each have a wave shape meandering in the direction of the stitch row 40a. Accordingly, the plurality of wires 30 (the conductor wires 31) can be disposed such that the wires 30 (the conductor wires 31) do not overlap each other at the position of the stitch row 40a, and thus, the wires 30 can be suppressed from rubbing each other during load application. Therefore, it is possible to suppress occurrence of damage of the dielectric body 32 covering the conductor wire 31, which may result in short circuit between the electrically-conductive elastic body 13 and the conductor wire 31.

### Modification 1 of Embodiment 2

In Embodiment 2, as shown in FIG. 13, the wire structure ST is configured such that the wires 30 each meandering in a curved shape are close to each other at the position P2. However, the wire structure ST may be configured such that the wire 30 each meandering in a straight line shape are close to each other at the position P2.

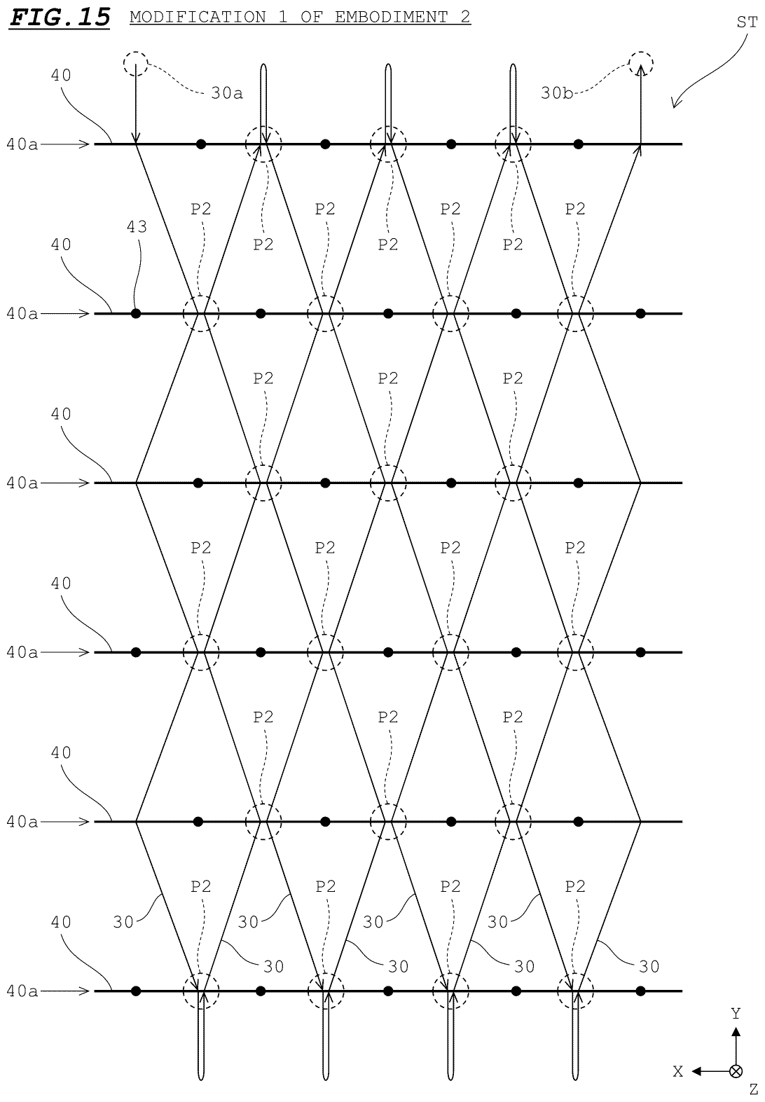

FIG. 15 is a plan view showing a configuration of the wire structure ST according to Modification 1 of Embodiment 2.

In the present modification as well, similar to Embodiment 2, the plurality of wires 30 each have a shape meandering in the direction (the X-axis direction) of the stitch row 40a. However, in the present modification, each wire 30 has a straight line shape having a straight line portion that is non-parallel to the Y-axis direction. There are two kinds of the tilt direction of the wire 30 of the portion non-parallel to the Y-axis direction, i.e., the X-axis positive direction and the X-axis negative direction, and the tilt angles of the two kinds of the tilt direction are the same with each other.

In the present modification as well, end portions of the wires 30 adjacent to each other in the end portions in the Y-axis direction are connected to each other, whereby the eight wires 30 are continuous. In FIG. 15, a route from the end portion 30a to the end portion 30b when the eight wires 30 are disposed in a continuous manner is indicated by solid line arrows.

At the position P2 of the present modification as well, similar to the configuration shown in FIG. 5B, two wires 30 close to each other are sandwiched between adjacent two stitches 43, and these two wires 30 are sewn and fastened to the first base member 11 by the thread 40.

Thus, in Modification 1 of Embodiment 2 as well, similar to Embodiment 2, a plurality of the conductor wires 31 close to each other at the position P2 on the stitch row 40a can be collectively sewn and fastened to the first base member 11. Therefore, the interval between the sewing-and-fastening positions can be made wide, and thus, each conductor wire 31 can be appropriately sewn and fastened.

As shown in FIG. 15, the plurality of wires 30 (the conductor wire 31) each have a shape meandering in the direction of the stitch row 40a. Accordingly, the plurality of wires 30 (the conductor wires 31) can be disposed such that the wires 30 (the conductor wires 31) do not overlap each other at the position of the stitch row 40a, and thus, the wires 30 can be suppressed from rubbing each other during load application. Therefore, it is possible to suppress occurrence of damage of the dielectric body 32 covering the conductor wire 31, which may result in short circuit between the electrically-conductive elastic body 13 and the conductor wire 31.

### Modification 2 of Embodiment 2

In Embodiment 2, as shown in FIG. 13, end portions of the wires 30 adjacent to each other in the end portions in the Y-axis direction are connected to each other, whereby the eight wires 30 are continuous. However, each wire 30 may be divided from each other.

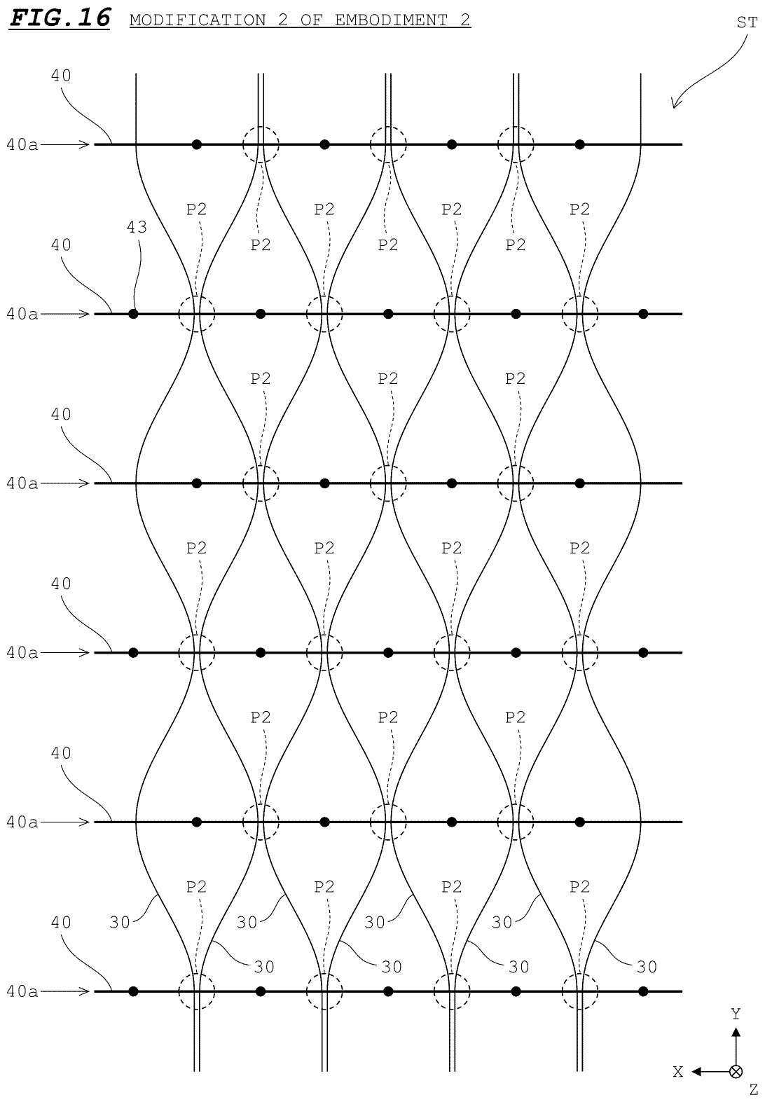

FIG. 16 is a plan view showing a configuration of the wire structure ST according to Modification 2 of Embodiment 2.

As compared with Embodiment 2 shown in FIG. 13, the wire structure ST of the present modification is not composed of the wires 30 that are continuous. That is, in the present modification, eight wires 30 that meander in the X-axis direction are each independently disposed. The shape in a plan view of the present modification is similar to that in Embodiment 2.

### Modification 3 of Embodiment 2

In Embodiment 1, the plurality of wires 30 are disposed such that two wires 30 cross each other in the gap between adjacent electrically-conductive elastic bodies 13, and in Embodiment 2, the plurality of wires 30 are disposed such that two wires 30 are close to each other in the gap between adjacent electrically-conductive elastic bodies 13. However, not limited thereto, two wires 30 may cross each other or be close to each other for each gap between adjacent electrically-conductive elastic bodies 13.

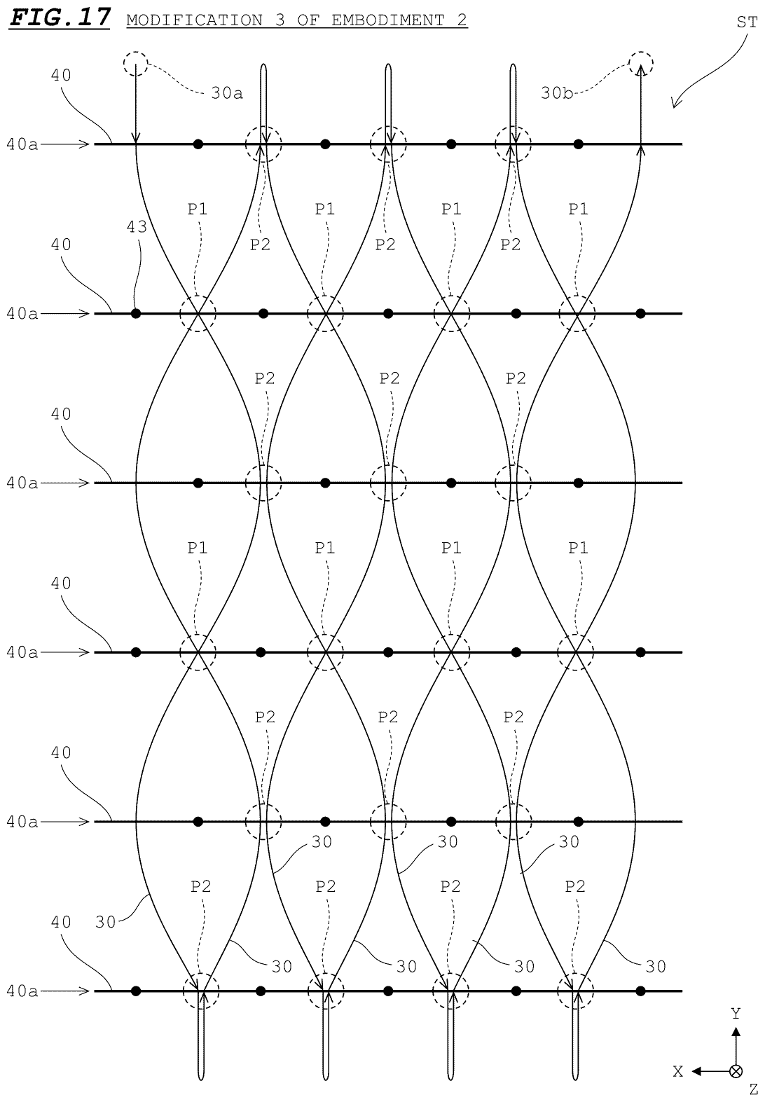

FIG. 17 is a plan view showing a configuration of the wire structure ST according to Modification 3 of Embodiment 2.

In the present modification, the eight wires 30 meander in the X-axis direction while extending toward the Y-axis direction. Similar to Embodiments 1, 2, each stitch row 40a is provided at a position at which the stitch row 40a does not overlap the electrically-conductive elastic body 13. With reference to FIG. 17, in the second and fourth stitch rows 40a from the Y-axis positive side, the positions P1 at each of which two wires 30 cross each other are provided, and in the third and fifth stitch rows 40a from the Y-axis positive side, the positions P2 at each of which two wires 30 are close to each other are provided.

In the present modification as well, end portions of the wires 30 adjacent to each other in the end portions in the Y-axis direction are connected to each other, whereby the eight wires 30 is continuous. In FIG. 17, a route from the end portion 30a to the end portion 30b when the eight wires 30 are disposed in a continuous manner is indicated by solid line arrows.

### Other Modifications

In the embodiments and modifications above, each wire 30 is configured to have a shape of either of a straight line shape and a curved shape. However, each wire 30 may include both of a portion of a straight line shape and a portion of a curved shape. In one wire structure ST, some wires 30 may be configured to have a straight line shape, and the other wires 30 may be configured to have a curved shape.

In Embodiment 1, Modifications 1, 3 of Embodiment 1, and Modification 1 of Embodiment 2 above, there are two kinds of the tilt direction of the wire 30 that is non-parallel to the Y-axis direction, and the tilt angles of the two kinds of the tilt direction are the same with each other. However, not limited thereto, the tilt angles of the two kinds of the tilt direction need not necessarily be the same. In Modification 2 of Embodiment 1, Embodiment 2, and Modifications 1 to 3 of Embodiment 2 above, the amplitudes of adjacent wires 30 are the same with each other. However, not limited thereto, the amplitudes of adjacent wires 30 need not necessarily be the same.

In the embodiments and modifications above, the position at which the wires 30 cross each other or are close to each other is a position that does not overlap the electrically-conductive elastic body 13 in a plan view, but not limited thereto, said position may be a position that overlaps the electrically-conductive elastic body 13 in a plan view. In this case, at the position that overlaps the electrically-conductive elastic body 13, the wires 30 cross each other or are close to each other, and at this position, the wires 30 are sewn and fastened by the thread 40. Therefore, in order to suppress influence of the stitch row 40a on the load detection, it is preferable that the position at which the wires 30 cross each other or are close to each other is a position that does not overlap the electrically-conductive elastic body 13, as described above.

In the embodiments and modifications above, the electrically-conductive elastic bodies 13 are disposed on the opposing face 11a of the first base member 11, but not limited thereto, may be disposed on the opposing face 61a of the second base member 61. Further, the electrically-conductive elastic bodies 13 may be disposed on both of the opposing face 11a of the first base member 11 and the opposing face 61a of the second base member 61.

In the embodiments and modifications above, the thread 40 is sewn to the first base member 11, but not limited thereto, may be sewn to the second base member 61.

In the embodiments and modifications above, the dielectric body 32 is set so as to cover the entire periphery of the conductor wire 31, but the dielectric body 32 may be disposed so as to cover at least, out of the surface of the conductor wire 31, only the range in which the contact area changes in accordance with the load. Further, although the dielectric body 32 is formed from one type of material in the thickness direction, the dielectric body 32 may have a structure in which two types or more of materials are stacked in the thickness direction.

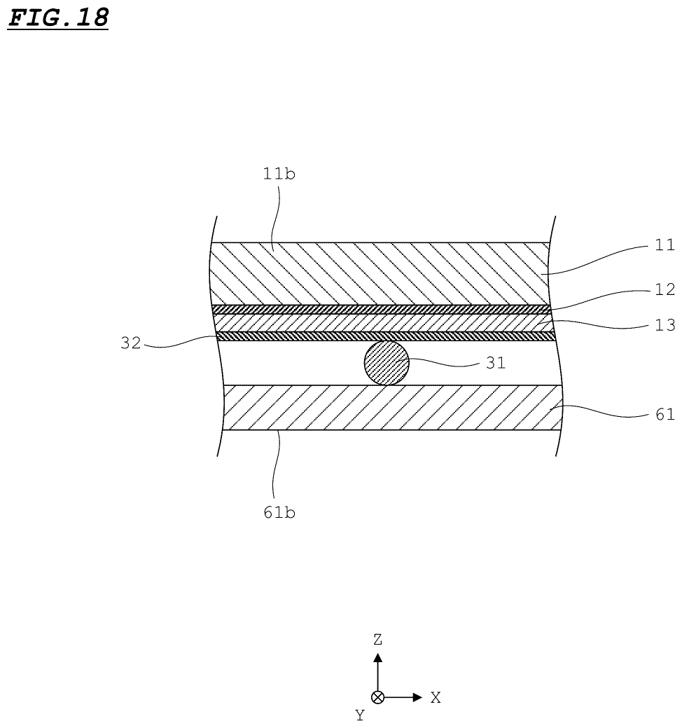

In the embodiments and modifications above, the dielectric body 32 is disposed on the surface of the conductor wire 31. However, the dielectric body 32, which defines the capacitance between the conductor wire 31 and the electrically-conductive elastic body 13, may be disposed between the conductor wire 31 and the electrically-conductive elastic body 13. For example, as shown in FIG. 18, the dielectric body 32 may be disposed on the surface of the electrically-conductive elastic body 13. In this case, the dielectric body 32 is formed from a material that can be elastically deformed so that the contact area with the conductor wire 31 changes in accordance with the load. For example, the dielectric body 32 is formed from a material having an elastic modulus similar to that of the electrically-conductive elastic body 13.

In the embodiments and modifications above, five wire structures ST are disposed and eight wires 30 are disposed in one element part A1. However, the number of the wire structures ST and the number of the wires 30 included in one element part A1 are not limited thereto. For example, the number of the wire structures ST may be one to four, or six or more, and the number of the wires 30 included in one element part A1 may be one to seven, or nine or more.

In the embodiments and modifications above, five electrically-conductive elastic bodies 13 are disposed. However, the number of the electrically-conductive elastic bodies 13 disposed in the load sensor 1 is not limited thereto. For example, the number of the electrically-conductive elastic bodies 13 may be one to four, or six or more.

In the embodiments and modifications above, the method of disposing the electrically-conductive elastic bodies 13 on the opposing face 11a of the first base member 11 is not necessarily limited to printing, and another method such as adhering a foil may be adopted.

In the embodiments and modifications above, the wire structure ST extends in the direction parallel to the arrangement direction (the Y-axis direction) of the electrically-conductive elastic bodies 13, but may extend in a direction non-parallel to the arrangement direction of the electrically-conductive elastic bodies 13. For example, the wire structure ST and the electrically-conductive elastic body 13 may diagonally cross each other.

In the embodiments and modifications above, the width of the electrically-conductive elastic body 13 need not necessarily be constant. For example, in the ranges between the element parts A1 in the direction (the X-axis direction) in which the electrically-conductive elastic body 13 extends, the width of the electrically-conductive elastic body 13 may be reduced.

In the embodiments and modifications above, the electric conductor 12 may be omitted, and the wiring cable 14 may be connected to the electrically-conductive elastic body 13.

In addition to the above, various modifications can be made as appropriate to the embodiments of the present invention without departing from the scope of the technical idea defined by the claims.

What is claimed is:

1. A load sensor comprising:
a first base member;
a second base member disposed so as to oppose the first base member;
a plurality of electrically-conductive elastic bodies disposed so as to be arranged on an opposing face of at least one of the first base member and the second base member;
a plurality of conductor wires disposed so as to cross the plurality of electrically-conductive elastic bodies;
a dielectric body disposed between the electrically-conductive elastic body and the conductor wire; and
a thread configured to sew and fasten the plurality of conductor wires to the first base member or the second base member by a stitch row extending in a direction crossing an arrangement direction of the plurality of electrically-conductive elastic bodies, wherein
the plurality of conductor wires are disposed such that, at a position of the stitch row, one of the conductor wires crosses another of the conductor wires or is close to the other of the conductor wires, and
the thread is sewn to the first base member or the second base member so as to extend across the one conductor wire and the other conductor wire that cross each other or are close to each other.

2. The load sensor according to claim 1, wherein
in a plan view, the stitch row is disposed in a gap between the electrically-conductive elastic bodies that are adjacent to each other.

3. The load sensor according to claim 1, wherein
in a plan view, the plurality of conductor wires are disposed along a plurality of straight lines tilted with respect to the arrangement direction, to form a plurality of meshes.

4. The load sensor according to claim 1, wherein
the plurality of conductor wires each have a wave shape meandering in the direction of the stitch row.

5. The load sensor according to claim 1, wherein
the plurality of conductor wires are configured to be continuous, with end portions thereof being connected to each other.

6. The load sensor according to claim 1, wherein
a pitch of stitches on the stitch row is 2 mm or more.

7. The load sensor according to claim 1, wherein
a plurality of sets each composed of the plurality of electrically-conductive elastic bodies and the plurality of conductor wires are disposed in a direction crossing the arrangement direction.

8. The load sensor according to claim 1, wherein
the dielectric body is set so as to cover a surface of the conductor wire.
